(19) United States
(12) Patent Application Publication
(10) Pub. No.: US 2009/0323319 A1
(43) Pub. Date: Dec. 31, 2009

(54) Cosmetic Mirror with a Light-Emitting Diode

(76) Inventor: Hui-Nan Lin, Kaohsiung City (TW)

Correspondence Address: Dr. BANGER SHIA, 102 Lindencrest Ct., Sugar Land, TX, 77479-5201, US

(21) Appl. No.: 12/146,389

(22) Filed: Jun. 25, 2008

(51) Int. Cl. F21V 33/00

(52) U.S. Cl. 362/144

(57) ABSTRACT

A cosmetic case with a light-emitting diode is provided with a pivoting unit and a control unit on an upper cover. The control unit positions the pivoting unit on the upper cover. Releasing the pivoting unit from the control unit can make the pivoting unit pivot with respect to the upper cover. The control unit supplies electric energy to the pivoting unit to make the light-emitting diode of the pivoting unit emit light for illumination.

### BACKGROUND OF THE INVENTION

1. Field of the Invention

The present invention relates to cosmetic accessories, and more particularly to a cosmetic mirror with a lighting-emitting diode.

2. Description of the Prior Art

A common cosmetic mirror comprises a lower case pivoted to an upper cover, a pressed powder is provided in the lower case, and the mirror is provided in the upper cover. In order to make the user share enough light at the time of making up, a technology (such as a cosmetic case with a light source disclosed in Taiwan Patent No. 094218070) has been developed.

However, when in use, most of the light sources, such as the tungsten lamp, the incandescent lamp, etc will generate high heat to cause the deterioration of the cosmetics.

The present invention has arisen to mitigate and/or obviate the afore-described disadvantages.

### SUMMARY OF THE INVENTION

The primary objective of the present invention is to provide a cosmetic case with a light-emitting diode, which unitizes a control unit to position a pivoting unit on an upper cove and enables the pivoting unit to pivot with respect to the upper cover when the pivoting unit is released from the control unit. The control unit supplies electric power to the pivoting unit to make the light-emitting diode of the pivoting unit emit light for illumination.

In order to achieve the above objective, the cosmetic mirror comprises a lower cover, an upper cover, a pivoting unit and a control unit. The upper cover is connected to the lower case in an openable and closeable manner. The pivoting unit is provided on the upper cover and can pivot with respect to the upper cover. The pivoting unit includes a spring and a light-emitting diode. The control unit is provided on the upper cover and connected to the light-emitting diode of the pivoting unit. The control unit can position the pivoting unit on the upper cover and compress the spring through rotating of the pivoting unit. The control unit includes a switch. When the pivoting unit is released from the control unit, the switch is closed, thus closing the circuit consisting of the control unit and the pivoting unit. Therefore, the control unit can supply the electric energy to the light-emitting diode of the pivoting unit.

### BRIEF DESCRIPTION OF THE DRAWINGS

FIG. 1 is an exploded view of a cosmetic mirror with a light-emitting diode in accordance with the present invention;

FIG. 2 is a perspective view of the cosmetic case mirror with a light-emitting diode in accordance with the present invention;

FIG. 3 is a schematic view showing the light-emitting diode of the present invention is emitting light;

FIG. 4 shows an open circuit consisting of a switch, a battery case and a light-emitting diode in accordance with the present invention; and

FIG. 5 shows a closed circuit consisting of the switch, the battery case and the light-emitting diode in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

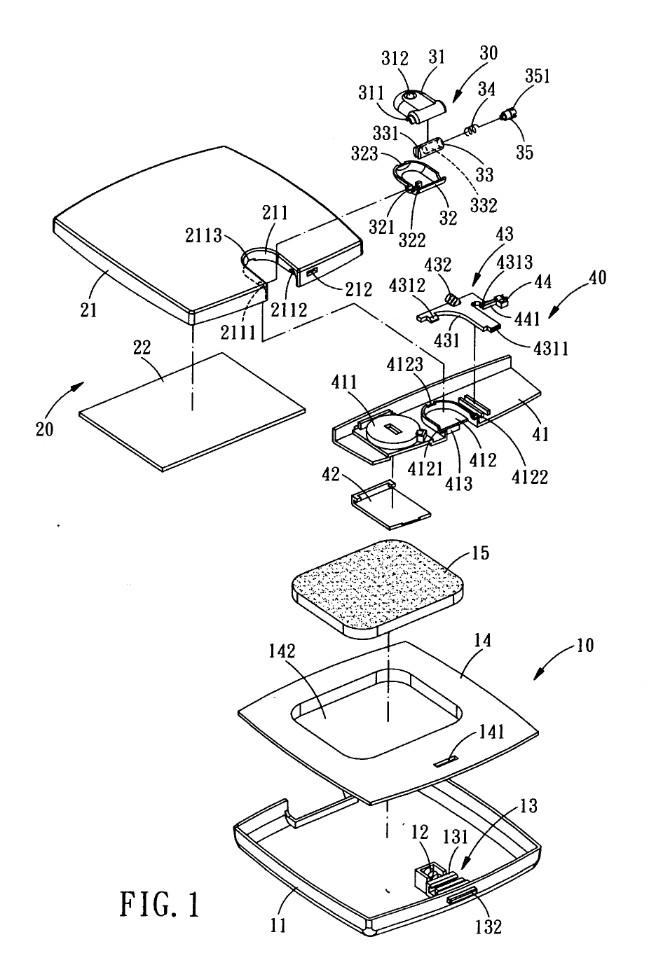

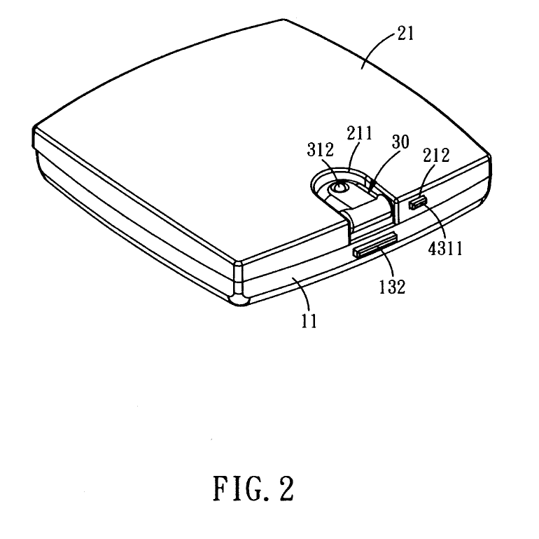

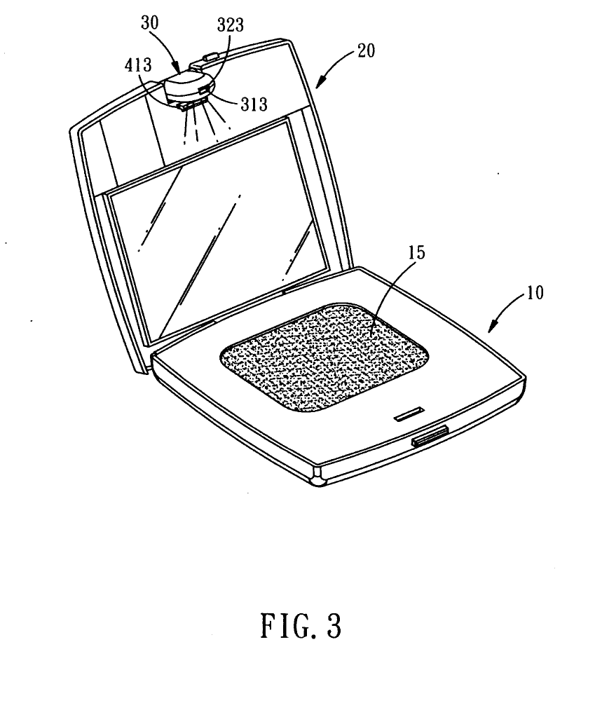

Referring to FIGS. 1-3, a cosmetic mirror with a light-emitting diode in accordance with the present invention comprises a lower case 10, an upper cover 20, a pivoting unit 30, and a control unit 40.

The lower case 10 includes a housing 11, a spring 12, a fastening component 13, a cover plate 14 and a pressed powder 15. One side of the housing 11 is formed with a through hole (unnumbered). The spring 12 and the fastening component 13 are disposed in the housing 11. The fastening component 13 includes a fastening hook 131 and a protruding block 132. The fastening component 13 is pressed by the spring 12 to move toward the through hole of the housing 11, and thus the protruding block 132 of the fastening component 13 protrudes out of the through hole. The cover plate 14 covers the housing 11 and includes a through hole 141 and a receiving groove 142. The fastening hook 131 of the fastening component 13 is arranged beside the through hole 141, and the receiving groove 142 is provided for placement of the pressed powder 15.

The upper cover 20 includes a housing 21 and a mirror 22. The housing 21 is connected to the housing 11 of the lower case 10 in an openable and closeable manner. The housing 21 is formed with a concave 211 which is formed with an opening 2111 and an engaging protrusion 2112 at two opposite sides thereof, and a positioning opening 2113 at another side thereof. The housing 21 is further formed with a through hole 212 adjacent to the concave 211. The mirror 22 is disposed in the housing 21.

The pivoting unit 30 is cooperatively provided in the concave 211 of the housing 21 of the upper cover 20 and includes a first housing 31, a second housing 32, a positioning pin 33, a spring 34 and an engaging block 35. The first housing 31 is provided with a first protrusion 311 at one side thereof, a positioning concave 313 at the other side thereof and a light-emitting diode 312. The second housing 32 is provided with at one side thereof with a second protrusion 321 in alignment with the first protrusion 311 of the first housing 31 and formed with an inner engaging protrusion 322. In addition, the other side of the second housing 32 also includes a positioning concave 323 in alignment with the positioning concave 313 of the first housing 31. The first housing 31 is combined to the second housing 32. The positioning pin 33 is accommodated in the first housing 31 and the second housing 32. One end of the positioning pin 33 is formed with an opening 331, which is engaged with the engaging protrusion 322 of the second housing 32 in such a manner that the positioning pin 33 is fixed in the first housing 31 and the second housing 32. The other end of the positioning pin 33 is formed with an axial groove 332 for accommodation of the spring 34. One end of the spring 34 is connected to the positioning pin 33, and the other end of the spring 34 is connected to one end of the engaging block 35, which is inserted in the groove 332 of the positioning pin 33. The other end of the engaging block 35 is formed with plural openings 325. The first protrusion 311 of the first housing 31 and the second protrusion 321 of the second housing 32 are both arranged in the opening 2111 of the concave 211 of the upper cover 20, and one of the plural openings 351 of the engaging block 35 is engaged to the engaging protrusion 2112 of the concave 211 of the housing 21.

The control unit 40 is provided on the housing 21 of the upper cover 20 and includes a base plate 41, a battery case cover 42, a positioning component 43 and a switch 44. The base plate 41 is provided on the housing 21 and includes a battery case 411, a concave 412 and a fastening hook 413. The battery case 411 is provided for holding a battery and connected to the light-emitting diode 312 of the first housing 31. The concave 412 is arranged in alignment with the concave 211 of the housing 21 of the upper cover 20 and provided for holding the pivoting unit 30. The concave 412 of the control unit 40 is further formed with an opening 4121, an engaging protrusion 4122 and a positioning opening 4123. The opening 4121 is provided for holding the first protrusion 311 of the first housing 31 and the second protrusion 321 of the second housing 32, and the engaging protrusion 4122 is provided for engaging with another opening 351 of the engaging block 35. The fastening hook 413 is arranged in alignment with the through hole 141 of the cover plate 14 of the lower case 10 and cooperates with the fastening hook 131 of the fastening component 13 of the lower case 10. The battery case cover 42 covers the battery case 411 of the base plate 41. The positioning component 43 includes a control sheet 431 and a spring 432. The control sheet 431 is slidably provided on the base plate 41 and includes a pushing protrusion 4311, a positioning protrusion 4312 and an actuating protrusion 4313 that all protrude in the same direction. The pushing protrusion 4311 protrudes out of the through hole 212 of the housing 21 of the upper cover 20. The positioning protrusion 4312 protrudes out of the positioning opening 2113 of the concave 211 of the housing 21 of the upper cover 20 and the positioning opening 4123 of the concave 412 of the base plate 41. The positioning protrusion 4312 is engaged in the positioning concaves 313, 323 of the first housing 31 and the second housing 32 of the pivoting unit 30 for positioning the pivoting unit 30. One end of the spring 432 is fixed on the control sheet 431, and the other end of the spring 432 abuts against the base plate 41, so as to make the control sheet 431 move in the direction in which the three protrusions 4311, 4312 and 4313 protrude. The switch 44 is provided on the housing 21 of the upper cover 20 and includes two separate connecting pins 441. While the two connecting pins 411 contact each other, the switch is on, the two connecting pins 441 are located in the direction in which the actuating protrusion 4313 of the control sheet 431 of the positioning component 43, and one pin 441 contacts the actuating protrusion 4313. Moreover, the two connecting pins 441 of the switch 44 are connected with the light-emitting diode 312 of the first housing 31 of the pivoting unit 30 and the battery case 411, respectively.

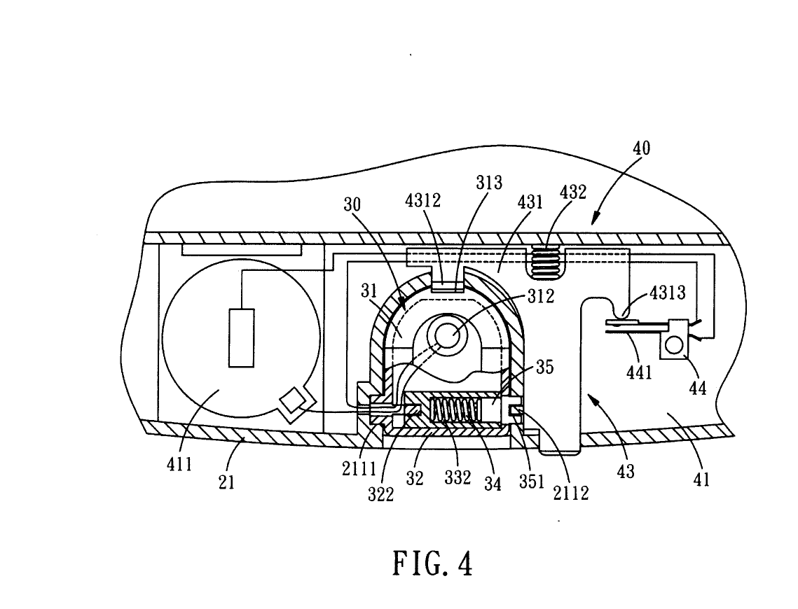

When the cosmetic mirror of the present invention is to be closed, the fastening hook 413 of the base plate 41 of the control unit 40 will be inserted through the through hole 141 of the cover plate 14 of the lower case 10 to fasten with the fastening hook 131 of the fastening component 13 of the lower case 10 in such a manner that the lower case 10 is closed with respect to the lower cover 20. The positioning protrusion 4312 of the control sheet 431 of the positioning component 43 of the control unit 40 is engaged in the positioning concaves 313, 323 of the first housing 31 and the second housing 32 of the pivoting unit 30 to position the pivoting unit 30 and compress the spring 34 through rotation of the pivoting unit 30. When the positioning protrusion 4312 is engaged in the two positioning concaves 313, 323, as shown in FIG. 4, the spring 432 of the positioning component 43 is compressed and the two connecting pins 441 of the switch 44 will separate from each other, and thus opening the circuit consisting of the switch 44, the battery case 411 of the base plate 41 and the light-emitting diode 312 of the first housing 31 of the pivoting unit 30.

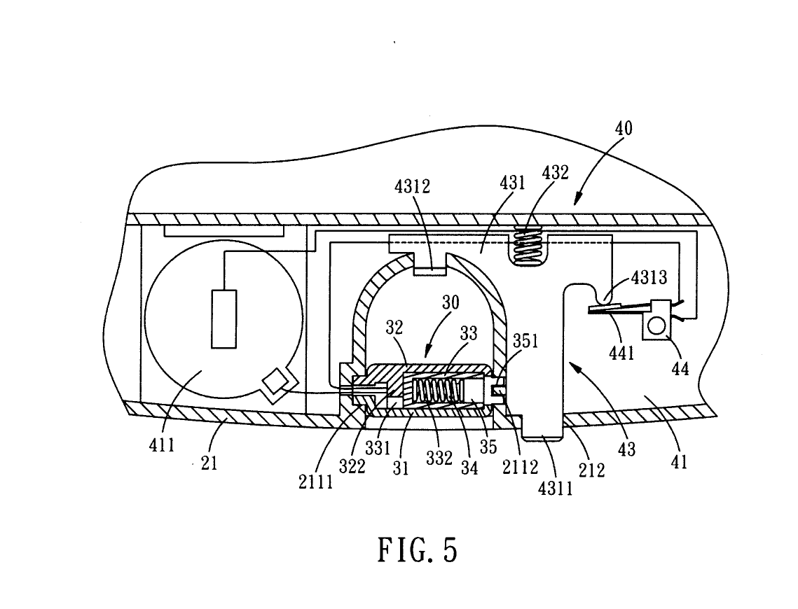

When the cosmetic mirror is to be opened, the protruding block 132 of the fastening component 13 of the lower case 10 is pressed down to release the fastening hook 131 of the fastening component 13 of the lower case 10 from the fastening hook 413 of the base plate 41 of the control unit 40, so that the lower case 10 can be opened with respect to the upper cover 20. When illumination is required, the pushing protrusion 4311 of the control sheet 431 of the positioning component 43 of the control unit 40 will be pressed down to make the positioning protrusion 4312 of the control sheet 431 disengage from the first housing 31 and the second housing 32 of the pivoting unit 30, and the spring 34 of the pivoting unit 30 will restore to its original state to drive the positioning pin 33 and the engaging block 35 of the pivoting unit and the to pivot with respect to each other. The positioning pin 33 is fixed in the first housing 31 and the second housing 32, and the engaging block 35 is engaged with the housing 21 of the upper cover 20, so the pivoting unit 30 and the upper cover 20 can pivot with respect to each other. When the positioning protrusion 4312 of the control sheet 431 disengages from the first housing 31 and the second housing 32 of the pivoting unit 30, as shown in FIG. 5, the spring 432 of the positioning component 43 will restore to its original state to press against the control sheet 431 to move, and then the control sheet 431 will use the actuating protrusion 4313 to push one of the connecting pins 441 of the switch 44 to move toward the other connecting pin 441, so as to make the two connecting pins 441 of the switch 44 contact each other, thus closing the circuit consisting of the switch 44, the battery case 411 of the base plate 41 and the light-emitting diode 312 of the first housing 31 of the pivoting unit 30. Therefore, the battery in the battery case 411 can supply the electric power to the light-emitting diode 312 to make the light-emitting diode 312 emit light for illumination.

While we have shown and described various embodiments in accordance with the present invention, it is clear to those skilled in the art that further embodiments may be made without departing from the scope of the present invention.

What is claimed is:

1. A cosmetic mirror with a light-emitting diode comprising:
a lower case;
an upper cover being connected to the lower case in an openable and closeable manner;
a pivoting unit being provided on the upper cover and pivotable with respect to the upper cover, the pivoting unit including a spring and a light-emitting diode; and
a control unit being provided on the upper cover and connected to the light-emitting diode of the pivoting unit, the control unit positioning the pivoting unit and compressing the spring of the pivoting unit through rotation of the pivoting unit, the control unit including a switch, when the pivoting unit is released from the control unit, the switch of the control unit will be closed to supply electric energy to the light-emitting diode of the pivoting unit.

2. The cosmetic mirror with a light-emitting diode as claimed in claim 1, wherein the upper cover includes a concave which is formed with an opening at one side thereof, the control unit includes a base plate, which is provided on the upper cover and formed with a concave in alignment with the concave of the upper cover, the concave of the control unit is formed with an opening in alignment with the opening of the upper cover, the pivoting unit includes a first housing, a second housing, a positioning pin and an engaging block, the first housing is provided with a first protrusion at one side thereof, the second housing is provided with a second protrusion at one side thereof, the first housing is combined to the second housing, the positioning pin is fixed in the first housing and the second housing, the positioning pin is formed at one end thereof with an axial groove for accommodation of the spring, one end of the spring is connected to the positioning pin, and the other end of the spring is connected to one end of the engaging block, which is inserted in the axial groove of the positioning pin, the first protrusion of the first housing and the second protrusion of the second housing are accommodated in the opening of the concave of the upper cover and the opening of the concave of the control unit, the other end of the engaging block is positioned in the concave of the upper cover and the concave of the control unit.

3. The cosmetic mirror with a light-emitting diode as claimed in claim 1, wherein the upper cover includes a concave which is formed at one side thereof with a positioning opening, the pivoting unit includes a first housing and a second housing, the first housing is provided with a positioning concave at one side thereof, the second housing is provided with a positioning concave at one side thereof, the first housing is combined to the second housing, the control unit includes a base plate and a positioning component, the base plate is provided on the upper cover and formed with a concave in alignment with the concave of the upper cover, the concave of the control unit is formed with a positioning opening in alignment with the positioning opening of the upper cover, the positioning component includes a control sheet and a spring, the control sheet is slidably provided on the base plate and includes a positioning protrusion and an actuating protrusion that protrude in the same direction, the positioning protrusion protrudes out of the positioning opening of the concave of the upper cover and the positioning opening of the concave of the base, the positioning protrusion is engaged in the positioning concaves of the first housing and the second housing to position the pivoting unit, one end of the spring is fixed on the control sheet, and the other end of the spring abuts against the base plate, the switch includes two separate connecting pins, when the two connecting pins contact each other, the switch is closed, the two connecting pins are arranged in a direction in which the actuating protrusion of the control sheet of the positioning component protrude, the two connecting pins of the switch are connected to the light-emitting diode of the pivoting unit, respectively.

4. A cosmetic mirror with a light-emitting diode comprising:
a lower case;
an upper cover being connected to the lower case in an openable and closeable manner, the upper cover including a concave, which is formed with an opening at one side thereof and a positioning opening at the other side thereof, the upper cover being further formed with a through hole adjacent to the concave;
a pivoting unit being disposed in the concave of the upper cover and including a first housing, a second housing, a positioning pin, a spring and an engaging block, the first housing being provided with a first protrusion at one side thereof, a positioning concave at the other side thereof and a light-emitting diode, the second housing being provided with a second protrusion at one side thereof and a positioning concave at the other side thereof, the first housing being combined to the second housing, the positioning pin being fixed in the first housing and the second housing, one end of the positioning pin being formed with an axial groove for accommodation of the spring, one end of the spring being connected to the positioning pin, and the other end of the spring being connected to one end of the engaging block, which is inserted in the axial groove of the positioning pin, the first protrusion of the first housing and the second protrusion of the second housing being accommodated in the opening of the concave of the upper cover, the other end of the engaging block being positioned in the concave of the upper cover; and
a control unit control unit being provided on the upper cover and including a base plate, a positioning component and a switch, the base plate being provided on the upper cover and including a battery case and a concave, the battery case being provided for holding a battery and connected to the light-emitting diode of the first housing, the concave of the base plate being arranged in alignment with the concave of the housing of the upper cover and provided for holding the pivoting unit, the concave of the control unit being further formed with an opening, an engaging protrusion and a positioning opening, the opening of the concave of the control unit being provided for holding the first protrusion of the first housing and the second protrusion of the second housing, the positioning component including a control sheet and a spring, the control sheet being slidably provided on the base plate and including a pushing protrusion, a positioning protrusion and an actuating protrusion that all protrude in the same direction, the pushing protrusion protruding out of the through hole of the upper cover, the positioning protrusion protruding out of the positioning opening of the concave of the housing of the upper cover and the positioning opening of the concave of the base plate, the positioning protrusion being engaged in the positioning concaves of the first housing and the second housing of the pivoting unit for positioning the pivoting unit, one end of the spring of the control unit being fixed on the control sheet, and the other end of the spring of the control unit abutting against the base plate, so as to make the control sheet move in the direction in which the three protrusions protrude, the switch being provided on the upper cover and includes two separate connecting pins, while the two connecting pins contact each other, the switch is closed, the two connecting pins are located in a direction in which the actuating protrusion of the control sheet of the positioning component protrudes, the two connecting pins of the switch are connected with the light-emitting diode of the first housing of the pivoting unit and the battery case, respectively.

5. The cosmetic mirror with a light-emitting diode as claimed in claim 4, wherein the second housing of the pivoting unit is formed with an engaging protrusion, and one end of the positioning pin of the pivoting unit is formed with an opening to be engaged with the engaging protrusion of the second housing.

6. The cosmetic mirror with a light-emitting diode as claimed in claim 2, wherein the concave of the upper cover is formed with an engaging protrusion at a side opposite the opening thereof, the concave of the base plate of the control unit is also formed with an engaging protrusion, the other end of the engaging block of the pivoting unit is formed with a plurality of openings, and two of the openings of the engaging block are respectively engaged with the engaging protrusions of the upper cover and the control unit.

7. The cosmetic mirror with a light-emitting diode as claimed in claim 4, wherein the control unit includes a battery case cover, which covers the battery case of the base plate of the control unit.

8. The cosmetic mirror with a light-emitting diode as claimed in claim 4, wherein the lower case includes a housing, a spring, a fastening component, a cover plate and a pressed powder, one side of the housing of the lower case is formed with a through hole, the spring and the fastening component of the lower case are disposed in the housing of the lower case, the fastening component of the lower case includes a fastening hook and a protruding block, the fastening component is pressed by the spring to move toward the through hole of the housing of the lower case, and thus the protruding block of the fastening component of the lower case protrudes out of the through hole, the cover plate of the lower cover covers the housing of the lower cover and includes a through hole and a receiving groove, the fastening hook of the fastening component of the lower case is arranged beside the through hole, and the receiving groove of the lower case is provided for placement of the pressed powder, the base plate of the control unit includes a fastening hook which is arranged in alignment with the through hole of the base plate of the cover plate of the lower case and cooperates with the fastening hook of the fastening component of the lower case.
